(19) United States
(12) Patent Application Publication
(10) Pub. No.: US 2002/0052218 A1
(43) Pub. Date: May 2, 2002

(54) Network-based system and method for supporting communications between a sender and a receiver upon requests of the receiver

(76) Inventor: Chul Rhee, Gyeonggi-do (KR)

Correspondence Address: PENNIE AND EDMONDS, 1155 AVENUE OF THE AMERICAS, NEW YORK, NY, 100362711

(21) Appl. No.: 09/756,988

(22) Filed: Jan. 8, 2001

(30) Foreign Application Priority Data
Oct. 5, 2000 (KR) 2000-58367

(51) Int. Cl. H04Q 7/20

(52) U.S. Cl. 455/552; 455/426; 455/412; 455/550; 455/445

(57) ABSTRACT

Disclosed are a system and method for establishing communications between a sender and the receiver depending on requests of the receiver, which implemented by the steps of storing connection information for a plurality of communication channels, for communication with said receiver, with access to each of said channels predefined as private or public; providing the access information of said communication channels to a sender; and establishing a connection between the sender and the receiver if a channel selected by the sender is private.

### FIELD OF THE INVENTION

The present invention relates to a telecommunications system; and, more particularly, to a system and method for establishing communications between a sender and a receiver as predefined by the receiver so that the personal information of the receiver is kept confidential.

### DESCRIPTION OF THE RELATED ART

Typically, a telecommunication system features a sender, a receiver and message to be transferred between them. The telecommunication is established when a communication device of the receiver responds to a call originated by the sender. Also, such establishment is achieved only when information associated with a telephone, cellular phone, Internet telephony, email or other communication device of the receiver is opened to the sender. Recently, personal information of clients (or subscribers) tends to be disclosed within limits to protect the privacy of the client and ensure communication privacy. Under such a circumstance, it is desirable to establish communications between the sender and the receiver depending on requests of the receiver, without publishing unwanted personal information of the receiver or adversely affecting the privacy of the receiver.

### SUMMARY OF THE INVENTION

It is, therefore, a primary object of the present invention to provide a system and method which is capable of controlling communication information associated with a receiver to thereby establish communications between a sender and the receiver depending on requests of the receiver, without publishing unwanted personal information of the receiver or adversely affecting the privacy of the receiver.

In accordance with a preferred embodiment of the present invention, there is provided a system for selectively establishing communications between a sender and a receiver, which comprising: databases for storing connection information for a plurality of communication channels, for communication with said receiver, with access to each of said channels predefined as private or public; a means for providing the access information of said communication channels to a sender; and means for establishing a connection between the sender and the receiver if a channel selected by the sender is private.

### BRIEF DESCRIPTIONS OF THE DRAWINGS

The above and other objects and features of the present invention will become apparent from the following description of preferred embodiments given in conjunction with the accompanying drawings, in which:

FIG. 1 is a schematic block diagram of a system for establishing communications between a sender and a receiver depending on requests of the receiver, in accordance with a preferred embodiment of the present invention;

FIG. 2 is a diagram of a screen to be downloaded to the client computer during sign-up;

FIG. 3A is an explanatory receiver inquiry screen which is downloaded to the sender from the system of the present invention;

FIG. 3B is an explanatory screen displayed thereon the inquired result which is transmitted to the sender;

FIG. 3C is an explanatory screen of private communication devices to be provided to the sender;

FIG. 4 is a schematic block diagram illustrating a real-time communication scheme in accordance with the present invention;

FIG. 5 is a schematic block diagram illustrating a message transmission scheme in accordance with the present invention;

FIG. 6 is a flow chart set forth a procedure, which a sender connects to the inventive system to communicate with a wanted receiver;

FIG. 7 is a flow chart set forth the real-time communication scheme in accordance with the present invention;

FIG. 8 is a flow chart set forth the message transmission scheme in accordance with another preferred embodiment of the present invention; and

FIG. 9 is a flow chart illustrating a message transmission scheme in which message receipt time data is previously set, in accordance with another preferred embodiment of the present invention.

### DETAILED DESCRIPTION OF THE PRESENT INVENTION

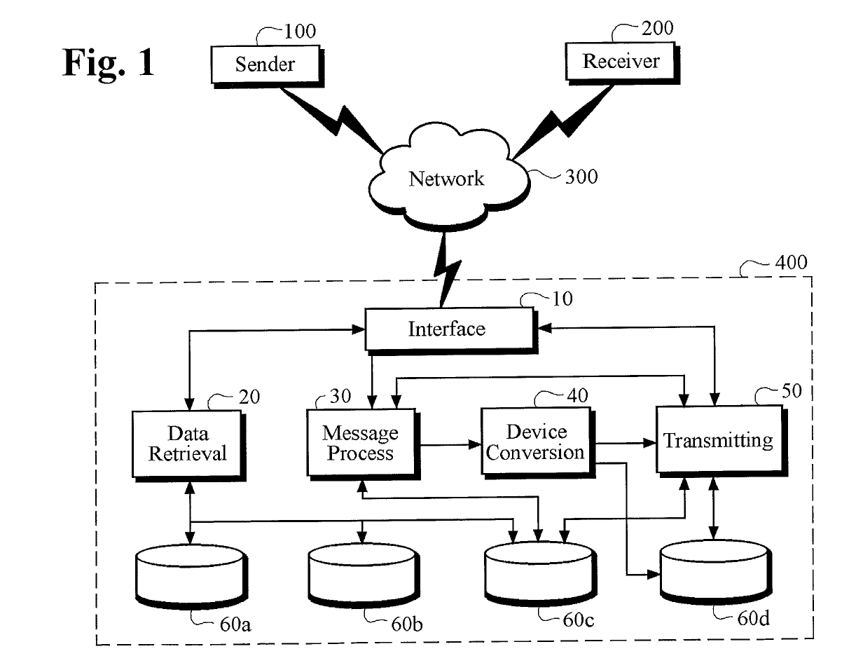

FIG. 1 is a block diagram of a system, in accordance with a preferred embodiment of the present invention, for establishing communications between a sender and a receiver as predefined by the receiver.

The system 400 establishes communications between a sender communication device 100 and a receiver communication device 200 via a network 300 such as the Internet, according to conditions predefined by the receiver. The sender and receiver communication devices 100 and 200 may be a telephone, facsimile, cellular phone, computer-based Internet telephony or E-mail, although it is not limited thereto. The network 300 may be a wired or wireless Internet or a value added network (VAN) connecting between the sender and receiver communication devices 100 and 200, although it is not limited thereto.

A preferred embodiment of the present invention based on the Internet will be described referring to Fig.l.

The system 400 comprises an interface 10, a data retrieval block 20, a message process block ³0, a device conversion block 40, a transmitting block 50 and a multiplicity of databases 60a, 60b, 60c and 60d.

In case a client wishes to sign up to the web site of the present invention using his or her own personal computer, the web site forwards a screen 70 to the client computer via the network 300 to thereby allowing the client to enter his or her own personal information thereon.

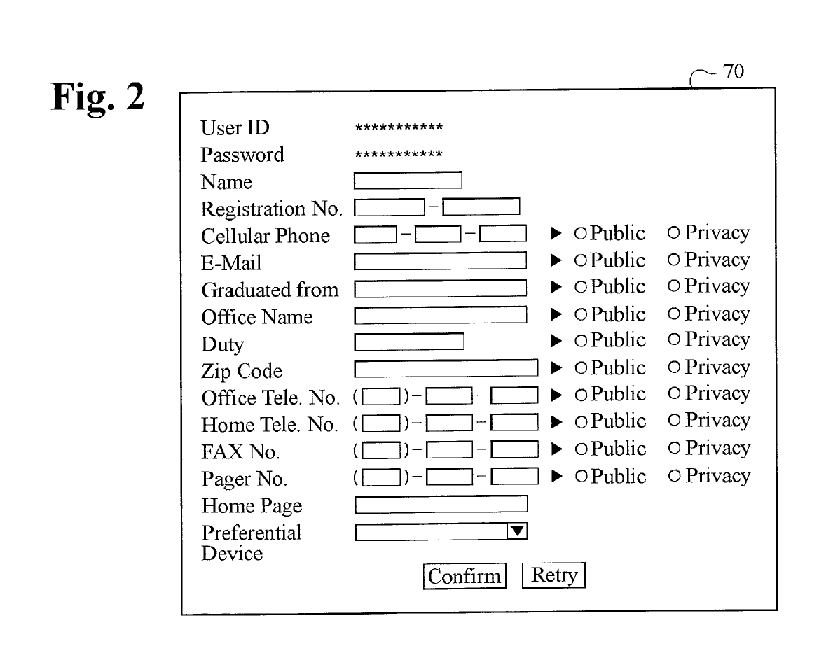

FIG. 2 is a diagram of the screen to be downloaded to the client computer during sign-up.

As shown in FIG. 2, the client enters on corresponding section in the screen 70 his or her own identification data, password, name, cellular phone number, E-mail address, graduated from, company name, zip code, telephone number, facsimile number of his or her office, the duty, telephone number and zip code of his or her home, or other communication information, by using a data input device such as a keyboard. In accordance with the present invention, such information may be set in a “public mode” or a “privacy mode” upon the selection of the client. Wherein, the public mode means that the client permits his or her own personal information to be published, and the privacy mode means that the client don't want to be published his or her own personal information.

Upon the entry of the personal information and the setting of the public mode or the privacy mode to each communication device, a confirmation button “Confirm” provided on the screen 70 is struck to terminate the sign up procedure.

Referring back to FIG. 1, the first database 60a stores thereon a multiplicity of client (subscriber) identify information each having an identification, password and name associated with each client. The second database 60b stores thereon a multiplicity of communication information each having the number of a telephone, cellular phone, facsimile or Internet telephony which each subscriber uses as a communication device, a public mode (or the privacy mode) specified to each communication device, a preferential one among the communication devices and the like. The third database 60c stores thereon connection data corresponding to each of the communication devices. The fourth database 60d stores thereon message transmitted to the system 400 from the sender communication device 100.

If the sender communication device 100 connects to the system 400 via the network 300, the interface 10 senses a transfer protocol of the sender communication device 100 and converts it to a protocol that is adapted to use in the system 400 of the present invention. The interface 10 also serves to convert message to be outputted therefrom into a format that is adapted to use in the receiver communication device 200.

When the sender communication device 100 connects to the web site employing the system 400 via the network 300, the system 400 forwards a screen for inquiring a receiver with which the sender wants to communicate to the sender communication device 100 via the interface 10 and the network 300.

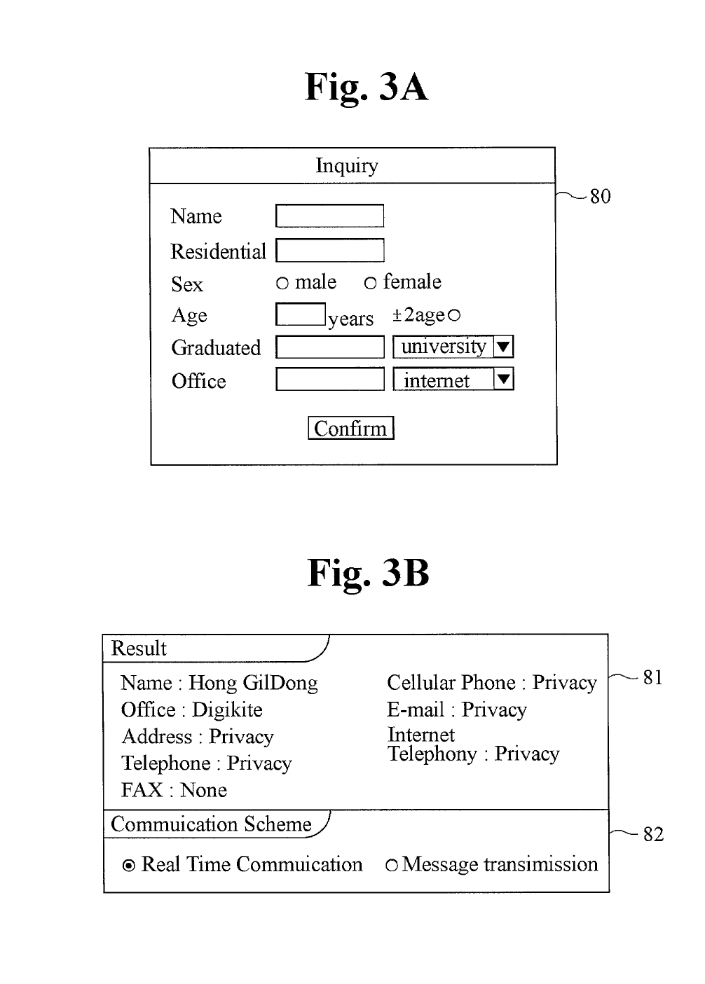

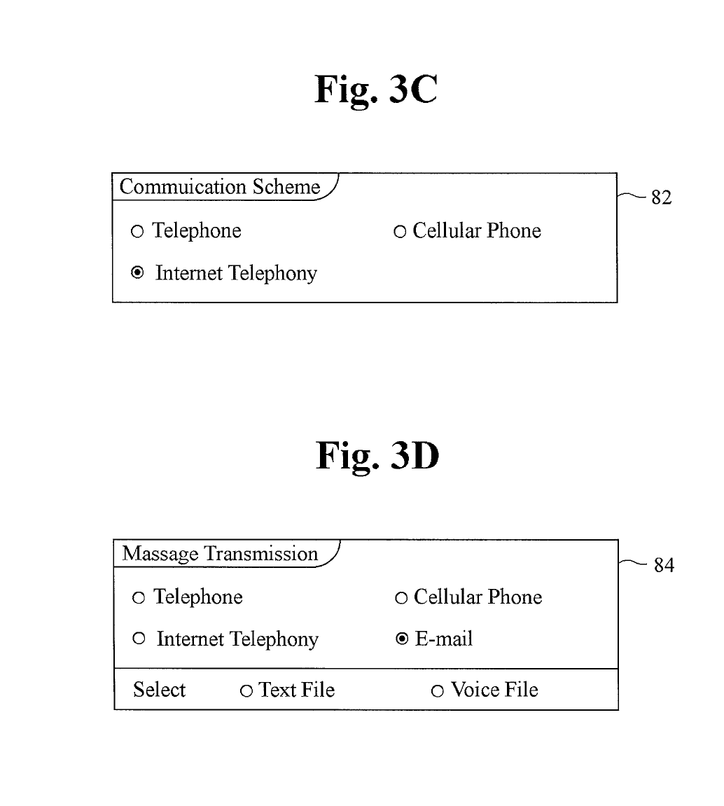

FIG. 3A is an explanatory receiver inquiry screen which is transmitted from the system 400 of the present invention. As shown in FIG. 3A, the receiver inquiry screen 80 is provided with a multiplicity of sections to be entered basic information for the wanted receiver, including a name, residential district, sex, age, education and office of the wanted receiver, although it is not limited thereto.

Thereafter, if the sender enters corresponding data on each section and strikes a “confirm” button provided on the receiver inquiry screen 80, a request for the receiver inquiry is transmitted to the data retrieval block 20 in the system 400 via the network 300.

In response to the request originated by the sender, the data retrieval block 20 retrieves the identify information, the public and privacy modes for each communication device, and connection data assigned to each of the communication devices which correspond to the wanted receiver from the databases 60a, 60b and 60c, respectively; and forwards a screen on which the inquired result is displayed to the sender communication device 100 via the network 300.

FIG. 3B is an explanatory screen displayed thereon the inquired result which is transmitted to the sender.

In FIG. 3B, the screen 81 displays the resultant data including an address, telephone number, cellular phone number, E-mail address, Internet telephony number of the inquired receiver, each of which is specified in the privacy mode. In addition, the system 400 of the present invention provides a communication menu such as a real-time communication scheme and a message transmission scheme to the sender, to thereby allow the sender to select one of the schemes, if desired.

Specifically, in case the sender wishes to communicate with a receiver in a real-time through one of the private communication devices, the sender first selects the real-time communication scheme on the menu. Then, the system 400 provides information of the private communication devices to the sender as shown in FIG. 3C. The sender chooses a wanted one of the communication devices specified in the privacy mode, e.g., the Internet telephony, and makes a request for the real-time communication with the receiver.

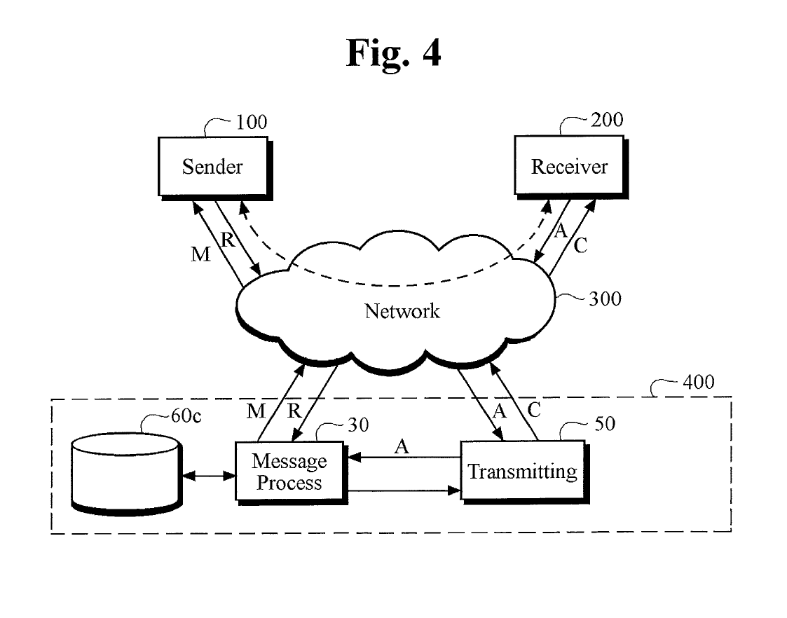

FIG. 4 is a schematic block diagram illustrating the real-time communication scheme in accordance with a preferred embodiment of the present invention.

As shown in FIG. 4, when a request R for the real-time communication using the Internet telephony is originated by the sender communication device 100, the message process block 30 of the system 400 retrieves a connection number corresponding to the Internet telephony of the receiver from the third database 60c and passes it to the transmitting block 50. The transmitting block 50 may be, e.g., a mail server, which originates a call C for determining if the Internet telephony of the receiver is being in a receiveenable state, based on the connection number fed thereto from the message process block 30.

If an acknowledge signal A is received from the sender by the transmitting block 50 within a predetermined time period, the transmitting block 50 directs it to the message process block 30. In response to the acknowledge signal A, the message process block 30 determines that the Internet telephony of the receiver is being in a receive-enable state, to allow the sender and the receiver to communicate with each other through the network 300, as indicated by a dotted line in FIG. 4. Otherwise, the message process block 30 determines that the Internet telephony of the receiver is being in a receive-disable state, and notifies the sender of message M indicating the receive-disable state of the receiver.

By using the real-time communication scheme discussed above, the present invention has the ability to support a one-to-one communication, voice over Internet protocol (VoIP) and chatting between the sender and the receiver, without disclosing the personal information associated with the receiver.

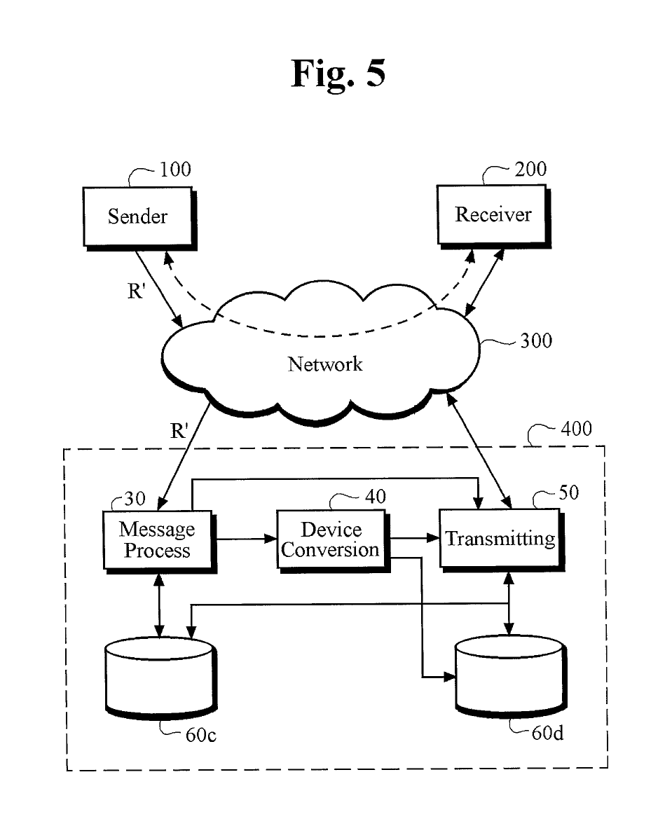

FIGS. 3D and 5 are schematic block diagrams illustrating the message transmission scheme in accordance with another preferred embodiment of the present invention.

If the sender wishes to transmit a message to the receiver through one of the private communication devices, the sender selects the message transmission scheme on the menu. Then, the system 400 provides the private communication devices to the sender as shown in FIG. 3C. The sender chooses a wanted one among the private communication devices, e.g., E-mail. Next, the sender writes a message to be transmitted to the receiver using a data entry device such as a keyboard, and make a request for the message transmission. As shown in FIG. 3D, options of the message may include a text file or voice file.

Specifically, as shown in FIG. 5, if a request R′ for the message transmission from the sender is received by the message process block 30, it retrieves E-mail address data corresponding to the receiver from the third database 60c, and relays the same together with the message to the transmitting block 50 or the device conversion block 40. In this case, direct relay of the message to the transmitting block 50 represents that the sender communication device 100 and the receiver communication device 200 are in congruity with each other.

When the sender communication device 100 is in incongruity with the receiver communication device 200, the device conversion block 40 converts the message from the sender to the format of a communication device required by the receiver. The message includes an email, voice mail, short message, facsimile, or the like. The message conversion includes a TTS (Text to Speech), STT (Sound to Text), TTF (Text to Facsimile), or the like, although it is not limited thereto. The message processed by the device conversion block 40 is relayed to the transmission block 50.

The transmission block 50 transmits the message fed directly thereto from the message process block 30 or the message processed at the device conversion block 40 to the receiver communication device 200 via the network 300.

In accordance with the present invention, options include a scheduling and delivery of message, and a scheduling and reception of message. That is, the sender may set a desired message delivery time and the receiver may set a desired message receipt time. If the message delivery time data is included in a message, the transmission block 50 temporarily stores the message from the message process block 30 or the message from the device conversion block 40 in the fourth database 60d. At the message delivery time, the transmission block 50 retrieves the message from the fourth database 60d and initiates delivery of the message to the receiver. Further, if the message receipt time data has been previously set in the system 400, the transmission block 50 temporarily stores the message from the message process block 30 or the message from the device conversion block 40 in the fourth database 60d. Thereafter, at the message receipt time, the transmission block 50 retrieves the message from the fourth database 60d and initiates delivery of the message to the receiver. As is well known, the receiver can connect to the transmission block 50 of the present invention by a typical login procedure to access to the message stored in the fourth database 60d.

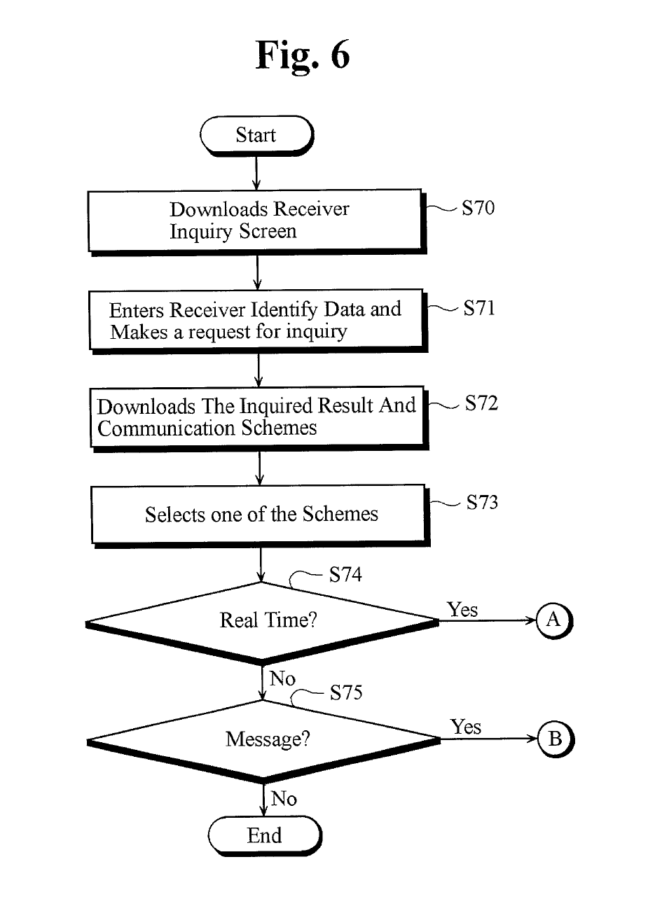

FIGS. 6 to 9 are flowcharts set forth a procedure, which a sender connects to the inventive system to communicate with a wanted receiver.

At step S70, if a connection between the sender and the inventive system 400 is established through a telephone, cellular phone, Internet telephony or other communication device, the system forwards the receiver inquiry screen 80 as shown in FIG. 3A to the sender.

At step S71, the sender enters receiver identify data on each section in the screen 80 and transmits a request for inquiry of the receiver to the system 400.

Upon the receipt of the request, at steps S72 and S73, the control process retrieves the identify information and the public and privacy modes for each communication device, which correspond to the wanted receiver, from the databases 60a and 60b shown in FIG. 1, respectively; and forwards the inquired result together with the communication schemes including a real-time communication and a message transmission to the sender communication device 100, to thereby allow the sender to select one of the schemes. If there is a public communication device on the inquired result, the sender may directly originate a call using the public communication device to the receiver.

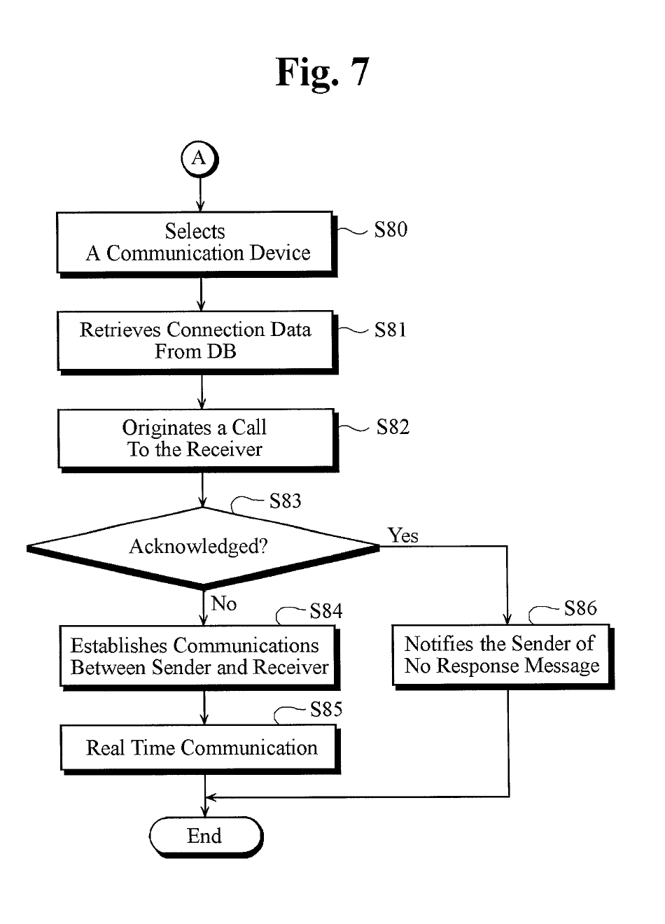

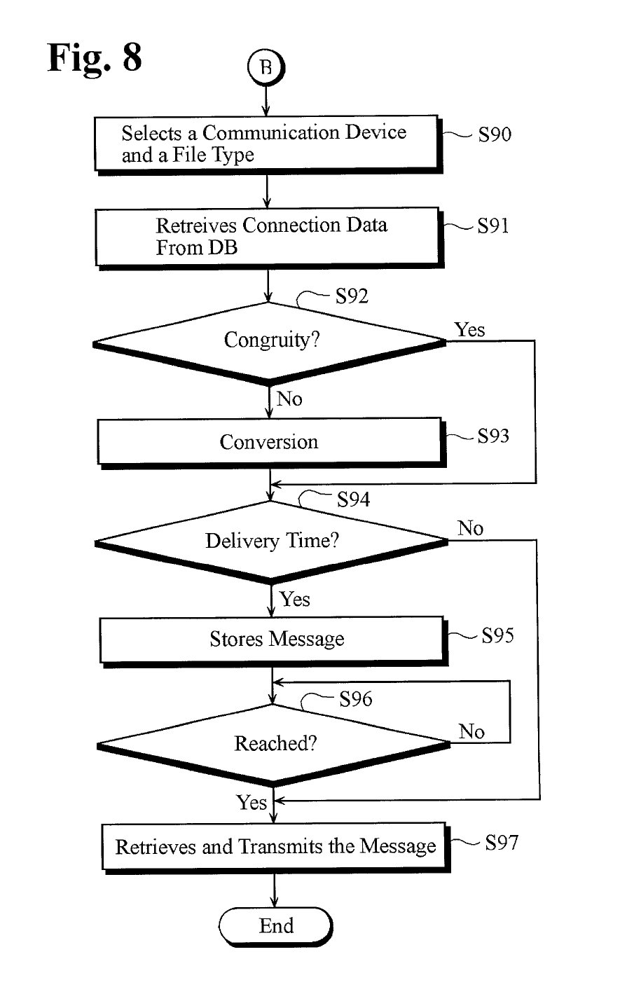

At step S74, the control process determines if the real-time communication scheme is selected. Being selected, the process proceeds to FIG. 7 via tap A wherein the real-time communication procedure is prosecuted. On the one side, Being selected the message transmission scheme at step S75, the process proceeds to FIG. 8 via tap B wherein the message transmission procedure is prosecuted.

FIG. 7 is a flow chart set forth the real-time communication scheme in accordance with the present invention.

At step S80, the sender selects one of the private communication devices, e.g., the Internet telephony, to make a request for the real-time communication with the receiver.

In response to the request, at step S82 the process retrieves connection data corresponding to the Internet telephony of the receiver from the third database 60c, and originates a call to the receiver based on the connection data.

A decision is made at step S83 to determine whether or not an acknowledge signal from the sender is received within a predetermined time period. When acknowledged, at step S84 the process determines that the receiver communication device 200 is in a receive-enable state, and allows communications between the sender communication device 100 and the receiver communication device 200 to be established. Thus, at step S85 the sender can communicate with the receiver in a real-time. On the other hand, when no acknowledged, the process goes to step S86 which determines that the receiver communication device 200 is in a receive-disable state, and notifies the sender 100 of no response message indicating the receive-disable state.

FIG. 8 is a flow chart set forth the message transmission scheme in accordance with another preferred embodiment of the present invention.

At step S90, the sender chooses one of the private communication devices, e.g., email, and then selects a type of message file to be transmitted to the receiver there through. Thereafter, the sender makes a request for the message transmission. The type of the message file may include at least one of a text, voice and dynamic picture image files.

In an ensuing step, the process, in response to the request, retrieves email address data corresponding to the receiver from the third database 60c at step S91, and checks whether or not the sender communication device 100 is in congruity with the receiver communication device 200 at step S92. If the checked result is NO, the process converts a transfer protocol of the sender communication device 100 to a protocol that is adapted to use in the email, to process the message from the sender.

Specifically, if the sender communication device 100 is a cellular phone having an Internet access function and the receiver communication device 200 is a computer, the process converts a message including a voice mail, short message and the like produced by the cellular phone into, e.g., a voice, text or facsimile format which the receiver can receive. The message conversion includes a TTS, STT, TTF, or the like, although it is not limited thereto. Meanwhile, if at step S92 the checked result is YES, the process goes to step S94 which checks if message delivery time data has been contained in the received message. If at step S94 the checked result is YES, at step S95 the process temporarily stores the message from the sender in the fourth database 60d and goes to step S96 wherein a decision is made to determine if the message delivery time is reached. At the message delivery time, at step S97 the process retrieves the message from the fourth database 60d and initiates delivery of the message to the receiver.

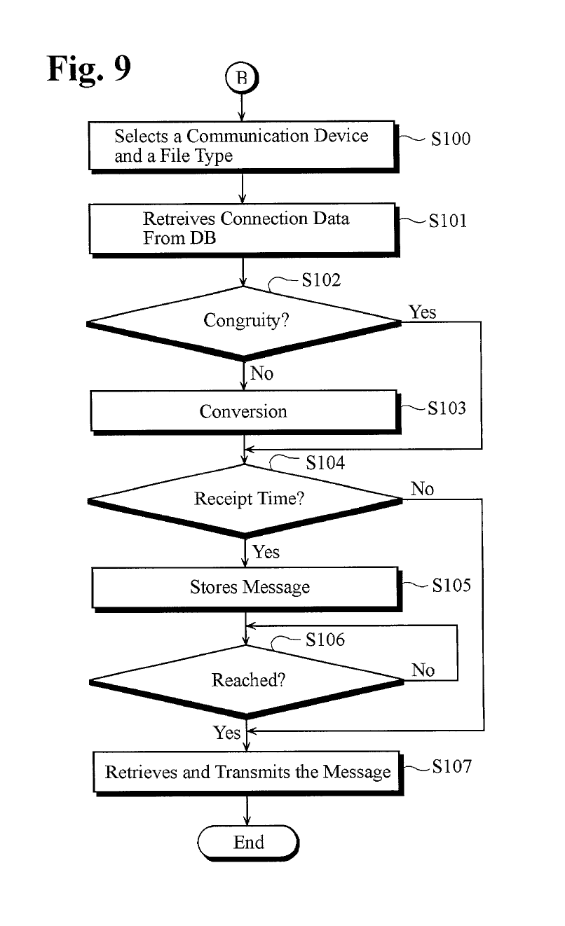

FIG. 9 is a flow chart illustrating a message transmission scheme in which message receipt time data is previously set, in accordance with another preferred embodiment of the present invention. In FIG. 9, steps S100 to S103 are similar to steps S90 to S93 shown in FIG. 8, and therefore a further description thereof is omitted herein.

A decision is made at step S104 to check if the message receipt time data has been set. If the checked result is YES, the process goes to step S105 wherein the message from the sender is temporarily stored in the fourth database 60d. After that, a decision is made at step S106 to check if the message receipt time is reached. When reached, at step S107 the process retrieves the message from the fourth database 60d and initiates delivery of the message to the receiver.

Further, the receiver connects the system 400 of the present invention through a typical login procedure if desired, to access message stored in the fourth database 60d.

As demonstrated above, the present invention allows a receiver to selectively set his or her own communication information to be public or private, thereby establishing communications between an originator and the receiver, without publishing any unwanted personal information of the receiver or affecting communication privacy of the receiver.

While the present invention has been described and illustrated with respect to a preferred embodiment of the invention, it will be apparent to those skilled in the art that variations and modifications are possible without deviating from the broad principles and teachings of the present invention which should be limited solely by the scope of the claims appended hereto.

What is claimed is:

1. A system for selectively establishing communications between a sender and a receiver, comprising:
means for storing connection information for a plurality of communication channels, for communication with said receiver, with access to each of said channels predefined as private or public;
means for providing the access information of said communication channels to a sender; and
means for establishing a connection between the sender and the receiver if a channel selected by the sender is private.

2. The system of claim 1, wherein the communication channels include a telephone, facsimile, cellular phone, Internet telephony and email communication.

3. The system of claim 2, wherein the connection information includes the unique identification of each of the communication channels.

4. The system of claim 1, which further comprises means for changing a communication protocol if a communication channel to the system from the sender is different from the selected communication channel from the system to the receiver.

5. The system of claim 4, wherein the establishing means includes:
means for determining if the receiver is able to communicate through the selected channel.

6. The system of claim 5, wherein the establishing means further includes:
means for converting a message type from the sender into a message type recognized by the receiver.

7. The system of claim 6, wherein said message includes a text or voice file.

8. The system of claim 6, wherein the establishing means further includes:
a first storing means for storing a message delivery time included in said the message; and
means for retrieving and transmitting said message at said message delivery time.

9. The system of claim 8, wherein the establishing means further includes:
a second storing means for storing a message receipt time included in the message; and
means for extracting and transmitting said message at said message receipt time.

10. A method for selectively establishing communications between a sender and a receiver, comprising the following steps of:
(a) storing connection information for a plurality of communication channels, for communication with said receiver, with access to each of said channels predef ined as private or public;
(b) providing the access information of said communication channels to a sender; and
(c) establishing a connection between the sender and the receiver if a channel selected by the sender is private.

11. The method of claim 10, wherein the communication channels include a telephone, facsimile, cellular phone, Internet telephony and email communication.

12. The method of claim 11, wherein the connection information includes the unique identification of each of the communication channels.

13. The method of claim 10, further comprising the step of changing a communication protocol if a communication channel to the system from the sender is different from the selected communication channel from the system to the receiver.

14. The method of claim 13, wherein said step (c) includes the step of determining if the receiver is able to communicate through the selected channel.

15. The method of claim 14, wherein said step (c) further includes the step of converting a message type from the sender into a message type recognized by the receiver.

16. The method of claim 15, wherein said message includes a text or voice file.

17. The method of claim 15, wherein said step (c) further includes the steps of:
(c1) storing a message delivery time included in said the message; and
(c2) retrieving and transmitting said message at said message delivery time.

18. The method of claim 17, wherein said step (c) further includes the step of:
(c3) storing a message receipt time included in the message; and
(c4) extracting and transmitting said message at said message receipt time.
